(19) United States
(12) Patent Application Publication
(10) Pub. No.: US 2005/0170276 A1
(43) Pub. Date: Aug. 4, 2005

(54) Chemical-amplification positive-working photoresist composition

(75) Inventors: Kazuyuki Nitta, Kawasaki-shi (JP); Naoto Motoike, Kawasaki-shi (JP)

Correspondence Address: WENDEROTH, LIND & PONACK, L.L.P., 2033 K STREET N. W., SUITE 800, WASHINGTON, DC, 20006-1021, US

(73) Assignee: TOKYO OHKA KOGYO CO., LTD., Kawasaki-shi, Kanagawa-ken (JP)

(21) Appl. No.: 10/514,320

(22) PCT Filed: Oct. 27, 2003
(86) PCT No.: PCT/JP03/13723

(30) Foreign Application Priority Data
Oct. 31, 2002 (JP) 2002-317934

(51) Int. Cl. G03C 1/492

(52) U.S. Cl. 430/270.1

(57) ABSTRACT

Disclosed is a chemical-amplification positive-working photoresist composition having compliability to various types of resist patterns with excellent sensitivity and pattern resolution exhibiting high exposure margin and focusing depth latitude. Of the essential components including (A) a resin capable of being imparted with increased alkali-solubility by interacting with an acid and (B) an acid-generating compound, the component (A) is a combination of (a1) a first resin and (a2) a second resin each as a hydroxystyrene-based copolymeric resin partially substituted for the hydroxyl hydrogen atoms with acid-dissociable solubility-reducing substituent groups. Characteristically, in addition to the difference in the mass-average molecular weight being high for (a1) and low for (a2), the acid-dissociability of the substituents in the (a1) resin is higher than that in the (a2) resin as in a combination of 1-ethoxyethyl for (a1) and tetrahydropyranyl for (a2).

### TECHNICAL FIELD

The present invention relates to a chemical-amplification positive-working photoresist composition used in the manufacture of semiconductor devices or, in particular, to a KrF positive-working resist composition which is compliable to any of line-and-space patterns, isolated pattern's, trench patterns and the like having different cross sectional profiles of the resist pattern.

### BACKGROUND ART

While it is only in recent years to attempt that a chemical-amplification positive-working photoresist composition is used as an ArF positive-working resist leading to partial practical service thereof, major application thereof is still as a KrF positive-working resist due to the expensiveness of the ArF exposure machines so that the major current for practical application is therewith down to a design rule of 90 nm and the effort of improvement is exclusively for a KrF positive-working resist composition suitable to the above-mentioned applications.

In the manufacture of semiconductor devices heretofore, the KrF positive-working resist compositions are under different requirements depending on applications which may be for the formation of a line-and-space pattern and may be for the formation of a hole pattern necessitating selection of a specific formulation of the resist composition suitable for the respective applications almost without availability of a single KrF positive-working resist composition suitable to any of these different applications.

Namely, conventional KrF positive-working resist compositions include those formulated with a base resin which is a mixture of two polyhydroxystyrene resins having different types of the acid-dissociable solubility-reducing groups (Japanese Patent Kokai 8-15864 and 8-262721), those formulated with a base resin which is a combination of two resins having the same type of the acid-dissociable solubility-reducing groups but in different degrees of protection with the ratio of the maximum and minimum values of the mass-average molecular weight smaller than 1.5 (Japanese Patent Kokai 2000-267283), those formulated with a base resin which is a combination of a plurality of copolymers each consisting of unsubstituted hydroxystyrene units and hydroxystyrene units substituted by respectively different acid-dissociable solubility-reducing groups (Japanese Patent Kokai 9-160246, 9-211868, 9-274320 and 9-311452), those with a base resin having acid-dissociable solubility-reducing groups which is a combination of a high molecular weight polymer having a molecular weight dispersion not exceeding 1.5 and a low molecular weight polymer having a molecular weight dispersion not exceeding-5.0 with a ratio of the mass-average molecular weights between the high and low molecular weight polymers both not smaller than 1.5 (Japanese Patent Kokai 9-90639) and others, each as proposed being not suitable for simultaneously satisfying the different requirements for the formation of a line-and-space pattern and for the formation of a hole pattern.

Further, it is a trend in recent years in the mass production of semiconductor devices such as system LSIs that simultaneous formation of resist patterns of different cross sectional profiles including line-and-space patterns, isolated patterns, trench patterns and others is increaseingly desired. Nevertheless, no positive-working resist compositions are available heretofore which can satisfy the various requirements for the desirable properties in these different types of the resist patterns with excellent sensitivity, pattern resolution and cross sectional profile as well as, in particular, light-exposure margin and focusing depth latitude.

### DISCLOSURE OF INVENTION

After continuing extensive investigations on the chemical-amplification positive-working resist compositions or, in particular, on those suitable for patterning exposure with KrF excimer laser beams with an object to improve the performance thereof, the inventors have arrived at a discovery that, when the base resin capable of being imparted with increased solubility in an alkali by interaction with an acid formulated in the composition as an essential ingredient thereof is a combination of specific two copolymers each having a narrow molecular weight dispersion and having different degrees of substitution with the acid-dissociable solubility-reducing groups and different mass-average molecular weights, improvements can be accomplished in the focusing depth latitude and exposure margin to be compliable with the various requirements for any of the line-and-space patterns, isolated patterns and trench patterns leading to completion of the present invention on the base of-this discovery.

Namely, the present invention provides a novel chemical-amplification positive-working photoresist composition comprising (A) a resinous ingredient capable of being imparted with increased solubility in alkali by interacting with an acid, which is a copolymer comprising hydroxystyrene units and hydroxystyrene units substituted for the hydroxyl hydrogen atoms by acid-dissociable solubility-reducing groups and (B) a photoacid generating compound capable of generating an acid by irradiation with radiation, of which the component (A) is a combination of two copolymers each having a molecular weight dispersion Mw/Mn of 1 to 4 consisting of a first copolymeric resin (a1) having a mass-average molecular weight in the range from 15000 to 30000, of which the degree of substitution of readily acid-dissociable solubility-reducing groups for the hydroxyl hydrogen atoms of the hydroxystyrene units not exceeding 25% by moles and a second copolymeric resin (a2) having a mass-average molecular weight in the range from 3000 to 10000 of which the degree of substitution for the hydroxyl hydrogen atoms in the hydroxystyrene units by less acid-dissociable than in (a1) solubility-reducing groups is at least 35% by moles.

While the chemical-amplification positive-working photoresist composition of the present invention comprises the basic ingredients including, similarly to conventional compositions of the same type, (A) a resin compound capable of being imparted with increased solubility in alkali by interacting with an acid and (B) a photoacid generator (PAG) which is a compound capable of generating an acid by irradiation with radiation, the most characteristic feature of the inventive composition consists in that the component (A) is a combination of two different resinous ingredients (a1) and (a2) each having a molecular weight dispersion Mw/Mn in the range from 1 to 4 including (a1) a first copolymeric resin having a mass-average molecular weight in the range from 15000 to 30000 and comprising monomeric units including not more than 25% by moles of hydroxystyrene units substituted for the hydroxyl-hydrogen atoms with readily acid-dissociable solubility-reducing substituent groups and (a2) a second copolymeric resin having a mass-average molecular weight in the range from 3000 to 10000 and comprising monomeric units including at least 35% by moles fraction of hydroxystyrene units substituted for the hydroxyl-hydrogen atoms with less acid-dissociable solubility-reducing substituent groups.

When generally categorized, the component (A) is a copolymeric resin comprising monomeric units including hydroxystyrene units and hydroxystyrene units substituted for the hydrogen atoms of the phenolic hydroxyl groups each with an acid-dissociable solubility-reducing group. The acid-dissociable solubility-reducing group as the substituent has an effect to decrease solubility in alkali and, while a copolymeric resin substituted with such substituent groups is imparted with decreased solubility in an alkali, the alkali-solubility of the copolymeric resin is increased in the presence of an acid due to dissociation of the substituent groups by interaction with the acid.

When a photoresist layer of a composition containing the components (A) and (B) in combination is pattern-wise exposed to radiation, accordingly, the resist layer, which is insoluble in alkali, is imparted on the exposed areas with increased alkali-solubility enabling alkali-development as a result of generation of an acid from the component (B) in the exposed areas to interact with the substituent groups of the component (A).

While a number of proposals are made heretofore for the base resins as a resinous component in a chemical-amplification positive-working photoresist composition, the component (A) in the inventive photoresist composition is a hydroxystyrene-based copolymeric resin comprising unsubstituted hydroxystyrene units and hydroxystyrene units substituted for the hydrogen atoms of the phenolic hydroxyl groups with acid-dissociable solubility-reducing substituent groups in consideration of several desirable properties including adequate solubility in alkali, good adhesion of the resist layer to the substrate surface and excellent heat resistance.

The hydroxystyrene unit above implied is a monomeric unit derived from styrene having one or more hydroxyl groups substituting for the hydrogen atom or atoms on the benzene ring of the styrene monomer. Optionally, the above-mentioned benzene ring can be substituted with other types of substituent groups such as alkyl groups and alkoxy groups having no adverse influences on the alkali-solubility of the resin to such an extent as not to decrease the alkali-developability. Further, the hydroxystyrene can be an α-substituted hydroxystyrene such as α-methyl hydroxystyrene.

It is essential in the inventive resist composition that the component (A) is a combination of two different hydroxystyrene-based copolymeric resins (a1) and (a2) substituted with acid-dissociable solubility-reducing groups differing in acid-dissociability. Namely, the substituent groups in the first resin (a1) must have acid-dissociability high enough as compared with those in the second resin (a2). The criterion for the acid-dissociability is given by the following test. Thus, a coating layer is formed on a substrate surface with a coating solution prepared by dissolving 100 parts by mass of a polyhydroxystyrene resin substituted with the substituent groups under testing and 5 parts by mass of bis(cyclohexylsulfonyl)diazomethane in a solvent and the coating layer is irradiated with KrF excimer laser beams followed by analysis to determine the extent of acid-induced dissociation of the substituent groups to regenerate the phenolic hydroxyl groups. The acid-dissociability of the substituent groups is taken as high when the degree of dissociation in the above test is at least 80% and taken as low when the degree of dissociation is less than 80%.

Particular examples of the highly acid-dissociable substituent groups by the above definition include chain alkoxyalkyl groups such as 1-ethoxyethyl, 1-(methoxymethyl)ethyl, 1-isopropoxyethyl, 1-methoxypropyl and 1-n-butoxyethyl groups. It is preferable that the first resin (a1) is a polyhydroxystyrene resin of which 25% by moles or less or, preferably, from 5 to 25% by moles or, more preferably, from 10 to 23% by moles of the monomeric units are substituted with the above-named highly acid-dissociable solubility-reducing groups.

The first resin (a1) has a relatively large mass-average molecular weight Mw in the range from 15000 to 30000 or, preferably, from 16000 to 25000. When the Mw value of the (a1) resin is too small, no sufficient exposure margin could be obtained while, when the Mw value is too large, the patterned resist layer of the resist composition would have a cross sectional profile trapezoidally non-orthogonal with footings.

The second resin (a2), on the other hand, is a copolymeric resin comprising hydroxystyrene monomeric units substituted with solubility-reducing groups having acid-dissociability lower than that in the first resin (a1) according to the above-mentioned criterion. Particular examples of such a poorly acid-dissociable substituent group include tertiary-alkyloxycarbonyl groups such as tert-butyloxycarbonyl and tert-amyloxycarbonyl groups, tertiary-alkyl groups such as tert-butyl and tert-amyl groups, tertiary-alkoxycarbonylalkyl groups such as tert-butyloxycarbonylmethyl and tert-amyloxycarbonylmethyl groups and cyclic ether groups such as tetrahydropyranyl and tetrahydrofuranyl groups.

The second resin as the ingredient (a2) is selected from those copolymers having hydroxystyrene monomeric units of which at least 35% by moles or, preferably, from 35 to 60% by moles or, more preferably, from 37 to 50% by moles fraction are substituted with the above-named less acid-dissociable solubility-reducing substituent groups for the hydrogen atoms of the phenolic hydroxyl groups. The second resin (a2) has a relatively small mass-average molecular weight Mw in the range from 3000 to 10000 or, preferably, from 5000 to 10000. When the Mw value of the second resin (a2) is too small, the resist layer formed from the resist composition suffers a decrease in the heat resistance and resistance against etching along with disadvantages of pattern falling and occurrence of defects.

It is desirable that each of the first resin (a1) and the second resin (a2) has a molecular weight dispersion Mw/Mn as small as possible or, preferably, in the range from 1 to 4. When good orthogonality is desired of the cross sectional profile of a patterned resist layer is desired, the Mw/Mn value of the (a1) and (a2) resins should be in the range from 1.0 to 2.5 or, more preferably, from 1.0 to 1.5.

It is optional according to need that the monomeric units constituting each of the first and second resins (a1) and (a2) include, besides the unsubstituted hydroxystyrene units and hydroxystyrene units substituted with the above described specific substituent groups, monomeric units of other types in a limited molar fraction. Such optional monomeric units of certain kinds may have an effect to impart adequate alkali-insolubility to the resist layer so that the patterning contrast can be increased between the exposed and unexposed areas of the resist layer.

Particular examples of the above-mentioned contrast-increasing monomeric units include those monomeric units derived from alkyl-substituted or unsubstituted α-methylstyrenes as well as non-acid-dissociable monomeric units derived from alkyl(meth)acrylate esters such as methyl and ethyl(meth)acrylates.

It is further optional that the monomeric units constituting each of the first and second resin (a1) and (a2) include, in addition to the above-mentioned acid-dissociable solubility-reducing substituent groups, solubility-reducing monomeric units of other types derived from tert-butyl(meth)acrylate, 1-methylcyclopentyl (meth)acrylate, 1-ethylcyclopentyl(meth)acrylate, 1-methylcyclohexyl(meth)acrylate, 1-ethylcyclohexyl (meth)acrylate, 2-methyladamantyl(meth)acrylate and 2-ethyladamantyl(meth)acrylate as well as those units crosslinked at the phenolic hydroxyl groups with a polyvinyl ether compound such as cyclohexanedimethanol divinyl ether and crosslinked diacrylate units esterified at the carboxyl group of (meth)acrylic acid with a tertiary dialcohol such as 2,5-dimethyl-2,5-hexane diol.

In consideration of the above-described various requirements, examples of polymeric resins preferable as the ingredient (a1) in the inventive resist composition include those named in (a), (b), (c) and (d) given below:
(a) polyhydroxystyrene resins having a mass-average molecular weight of 20000 with a molecular weight dispersion of 2.4, of which 5-25% by moles or, preferably, 10-23% by moles of the hydroxyl hydrogen atoms are substituted by 1-ethoxyethyl groups;
(b) polyhydroxystyrene resins having a mass-average molecular weight of 20000 with a molecular weight dispersion of 2.4, of which 5-25% by moles or, preferably, 10-23% by moles of the hydroxyl hydrogen atoms are substituted by 1-isopropoxyethyl groups;
(c) polyhydroxystyrene resins having a mass-average molecular weight of 18000 with a molecular weight dispersion of 1.3, of which 5-25% by moles or, preferably, 10-23% by moles of the hydroxyl hydrogen atoms are substituted by 1-ethoxyethyl groups; and
(d) polyhydroxystyrene resins having a mass-average molecular weight of 18000 with a molecular weight dispersion of 1.3, of which 5-25% by moles or, preferably, 10-23% by moles of the hydroxyl hydrogen atoms are substituted by 1-isopropoxyethyl groups.

Similarly, examples of the resins preferable as the ingredient (a2) include those given under (e) to (n) below:
(e) polyhydroxystyrene resins having a mass-average molecular weight of 10000 with a molecular weight dispersion of 2.4, of which 35-60% by moles or, preferably, 37-50% by moles of the hydroxyl hydrogen atoms are substituted by tert-butoxycarbonyl groups;
(f) polyhydroxystyrene resins having a mass-average molecular weight of 10000 with a molecular weight dispersion of 1.3, of which 35-60% by moles or, preferably, 37-50% by moles of the hydroxyl hydrogen atoms are substituted by tert-butoxycarbonyl groups;
(g) polyhydroxystyrene resins having a mass-average molecular weight of 10000 with a molecular weight dispersion of 2.4, of which 35-60% by moles or, preferably, 37-50% by moles of the hydroxyl hydrogen atoms are substituted by tert-butyl groups;
(h) polyhydroxystyrene resins having a mass-average molecular weight of 10000 with a molecular weight dispersion of 1.3, of which 35-60% by moles or, preferably, 37-50% by moles of the hydroxyl hydrogen atoms are substituted by tert-butyl groups;
(i) polyhydroxystyrene resins having a mass-average molecular weight of 10000 with a molecular weight dispersion of 2.4, of which 35-60% by moles or, preferably, 37-50% by moles of the hydroxyl hydrogen atoms are substituted by tert-butoxycarbonyl methyl groups;
(j) polyhydroxystyrene resins having a mass-average molecular weight of 10000 with a molecular weight dispersion of 1.3, of which 35-60% by moles or, preferably, 37-50% by moles of the hydroxyl hydrogen atoms are substituted by tert-butoxycarbonyl methyl groups;
(k) polyhydroxystyrene resins having a mass-average molecular weight of 10000 with a molecular weight dispersion of 2.4, of which 35-60% by moles or, preferably, 37-50% by moles of the hydroxyl hydrogen atoms are substituted by tetrahydropyranyl groups;
(l) polyhydroxystyrene resins having a mass-average molecular weight of 5000 with a molecular weight dispersion of 1.3, of which 35-60% by moles or, preferably, 37-50% by moles of the hydroxyl hydrogen atoms are substituted by tetrahydropyranyl groups;
(m) polyhydroxystyrene resins having a mass-average molecular weight of 5000 with a molecular weight dispersion of 2.4, of which 35-60% by moles or, preferably, 37-50% by moles of the hydroxyl hydrogen atoms are substituted by tetrahydrofuranyl groups; and
(n) polyhydroxystyrene resins having a mass-average molecular weight of 5000 with a molecular weight dispersion of 1.3, of which 35-60% by moles or, preferably, 37-50% by moles of the hydroxyl hydrogen atoms are substituted by tetrahydrofuranyl groups.

It is important in the formulation of the photoresist composition of the invention that the component (A) is a combination of one kind or more of the resins selected from the above given ingredients (a1) and one kind or more of the resins belonging to the above given ingredients (a2). In consideration of the preparation cost of the composition, it is preferable that the component (A) is a combination of a single kind of the (a1) resins and a single kind of the (a2) resins.

The above-described (a1) resins and (a2) resins are each known in the prior art and can be prepared by a known method. For example, the acid-dissociable solubility-reducing substituent groups can be introduced into a commercially available polyhydroxystyrene resin by a reaction in the presence of an acidic or basic catalyst. Alternatively, the copolymeric resin can be prepared from a monomer mixture consisting of unsubstituted hydroxystyrene monomer, a hydroxystyrene monomer substituted for the hydroxyl hydrogen atom by an acid-dissociable solubility-reducing group in the molecule and, optionally, a third comonomer by conducting a copolymerization reaction, for example, as a living anionic polymerization.

The mass proportion of the (a1) resin and (a2) resin to give the component (A) of the inventive composition is selected in the range from 1:9 to 9:1 or, preferably, from 2:8 to 8:2 while the proportion is subject to adjustment in consideration of the desired dissolution rate of the resin film in an aqueous alkaline solution. The dissolution rate here implied can be defined as an amount of film thickness reduction per unit time when a coating film of the resin or resin mixture formed on a substrate surface is dipped at 23° C. in a 2.38% by mass aqueous solution of tetramethylammonium hydroxide.

As a rough measure, the combination of the (a1) and (a2) resins is prepared in such a way that the resin mixture exhibits a dissolution rate in the range from 3 to 60 nm/minute or, preferably, from 6 to 40 nm/minute by using a resin (a1) exhibiting a dissolution rate of 30-200 nm/minute or, preferably, 50-100 nm/minute and a resin (a2) exhibiting a dissolution rate of 0.01-20 nm/minute or, preferably, 0.1-12 nm/minute.

In the chemical-amplification positive-working photoresist composition of the invention, it is essential that the composition contains the component (B) which is a compound capable of generating an acid when irradiated with a radiation, referred to as a PAG hereinafter. While a great variety of PAG compounds are known in the prior art as an ingredient in a chemical-amplification resist composition, any of those known in the prior art can be used in the present invention without particular limitations. In particular, preferable PAG compounds in the present invention include diazomethane compounds and onium salt compounds of which the anionic constituent is a fluoroalkylsulfonate ion having 1 to 15 carbon atoms in the anion.

Examples of the diazomethane compounds suitable as the component (B) include bis(p-toluenesulfonyl)diazomethane, bis(1,1-dimethylethylsulfonyl)diazomethane, bis(isopropylsulfonyl)diazomethane, bis(cyclohexylsulfonyl)diazomethane and bis(2,4-dimethylphenylsulfonyl)diazomethane.

Examples of the onium salt compounds suitable as the component (B) include diphenyliodonium trifluoromethanesulfonate and nonafluorobutanesulfonate, bis(4-tert-butylphenyl)iodonium trifluoromethanesulfonate and nonafluorobutanesulfonate, triphenylsulfonium trifluoromethanesulfonate and nonafluorobutanesulfonate, tri(4-methylphenyl)sulfonium trifluoromethanesulfonate and nonafluorobutanesulfonate, of which trifluoromethanesulfonate and nonafluorobutanesulfonate of diphenyliodonium or bis(4-tert-butylphenyl)iodonium are particularly preferred.

The amount of the component (B), which may be a single PAG compound or a combination of two kinds or more of different PAG compounds, in the inventive photoresist composition is in the range from 0.5 to 20 parts by mass or, preferably, from 1 to 10 parts by mass per 100 parts by mass of the copolymeric resin as the component (A). When the amount of the component (B) is too small, complete pattern formation can hardly be accomplished while, when too large, difficulties are encountered in obtaining a uniform solution due to the usually limited solubility of the PAG compounds with a decreased stability of the composition even if a uniform solution could be obtained.

It is optional that the inventive photoresist composition comprising the above-described components (A) and (B) is further admixed with a component (C) which is a polyvinyl ether compound capable of effecting crosslink formation with the resinous ingredient as the component (A) by a heat treatment or, in particular, by a prebaking treatment. Such a polyvinyl ether compound is represented by a general formula
A[O—(RO)ₘ—CH═CH₂]ₙ, (I)
in which A is a divalent to pentavalent residue of an organic compound, R is a lower alkylene group having, e.g., 1 to 4 carbon atoms, the subscript m is 0 or a positive integer not exceeding 5 and the subscript n is an integer of 2 to 5. Compounding the photoresist composition with such a polyvinyl ether compound has an effect of improving the thermal flow behavior of the resist layer.

Examples of the polyvinyl ether compounds suitable as the component (C) include ethyleneglycol divinyl ether, diethyleneglycol divinyl ether, triethyleneglycol divinyl ether, 1,4-butanediol divinyl ether, tetramethyleneglycol divinyl ether, tetraethyleneglycol divinyl ether, neopentylglycol divinyl ether, trimethylolpropane trivinyl ether, trimethylolethane trivinyl ether, hexanediol divinyl ether, 1,4-cyclohexanediol divinyl ether, tetraethyleneglycol divinyl ether, pentaerythritol divinyl ether, pentaerythritol trivinyl ether and cyclohexanedimethanol divinyl ether, of which alkyleneglycol divinyl ethers having an alicyclic group in the structure, such as cyclohexanedimethanol divinyl ether, are particularly preferable, although any one or any combination of the above named compounds can be used.

The amount of the component (C), which is a compound having at least two crosslinkable vinyl ether groups per molecule, is in the range, when used, from 0.1 to 25 parts by mass or, preferably, from 1 to 15 parts by mass per 100 parts by mass of the resinous ingredient as the component (A) of the inventive composition.

It is further optional that, in addition to the above-described components (A), (B) and, optionally, (C), the inventive photoresist composition is admixed with an aliphatic, aromatic or heterocyclic amine compound as a component (D) with an object to prevent deterioration of the resist pattern by standing before the post-exposure baking treatment or to improve the cross sectional profile of the patterned resist layer.

Examples of the aliphatic amine compounds as the component (D) include secondary or tertiary aliphatic amines such as trimethylamine, diethylamine, triethylamine, di-n-propylamine, tri-n-propylamine, triisopropylamine, dibutylamine, tributylamine, tripentylamine, diethanolamine, triethanolamine, diisopropanolamine and triisopropanolamine.

Examples of the aromatic amine compounds as the component (D) include benzylamine, aniline, N-methylaniline, N,N-dimethylaniline, o-methylaniline, m-methylaniline, p-methylaniline, N,N-diethylaniline, diphenylamine and di-p-tolylamine.

Examples of the heterocyclic amine compounds as the component (D) include pyridine, o-methylpyridine, o-ethylpyridine, 2,3-dimethylpyridine, 4-ehtyl-2-methylpyridine and 3-ethyl-4-methylpyridine.

Among the above-named amine compounds of various classes as the component (D), most preferable are the secondary or tertiary lower aliphatic amine compounds in respects of good cross sectional profile of the patterned resist layer and excellent stability after post-exposure baking treatment.

The amount of the amine compound as the component (D) in the inventive composition is, when used, in the range from 0.001 to 1 part by mass or, preferably, from 0.01 to 0.5 part by mass per 100 parts by mass of the component (A). When the amount thereof is too small, no improvement can be accomplished in the pattern resolution while, when too large, the photoresist composition rather suffers a decrease in the photosensitivity.

It is still further optional that, in addition to the above-described essential and optional components, the inventive photoresist composition is admixed with a carboxylic acid compound as a component (E) with an object to compensate for the decrease in the photosensitivity of the composition caused by the addition of an amine compound as the component (D) or to decrease the dependency of the cross sectional profile of the patterned resist layer on the material of the substrate on which the resist layer is formed.

The carboxylic acid as the component (E) is selected from saturated and unsaturated aliphatic carboxylic acids, alicyclic carboxylic acids, oxycarboxylic acids, alkoxycarboxylic acids, ketocarboxylic acids and aromatic carboxylic acids, though not particularly limitative thereto.

Examples of the saturated aliphatic carboxylic acids, which may be monobasic or polybasic, include formic acid, acetic acid, propionic acid, butyric acid, isobutyric acid, oxalic acid, malonic acid, succinic acid, glutaric acid and adipic acid.

Examples of the unsaturated aliphatic carboxylic acid include acrylic acid, crotonic acid, isocrotonic acid, 3-butenoic acid, methacrylic acid, 4-pentenoic acid, propiolic acid, 2-butynoic acid, maleic acid, fumaric acid and acetylene carboxylic acid.

Examples of the alicyclic carboxylic acids include 1,1-cyclohexane dicarboxylic acid, 1,2-cyclohexane dicarboxylic acid, 1,3-cyclohexane dicarboxylic acid, 1,4-cyclohexane dicarboxylic acid and 1,1-cyclohexyl diacetic acid.

The oxycarboxylic acid is exemplified by oxyacetic acid, the alkoxycarboxylic acid is exemplified by methoxy- and ethoxyacetic acids and the ketocarboxylic acid is exemplified by pyruvic acid.

Examples of the aromatic carboxylic acids, which may be unsubstituted or substituted by hydroxyl, nitro, vinyl and other substituent groups, include p-hydroxybenzoic acid, o-hydroxybenzoic acid, 2-hydroxy-3-nitrobenzoic acid, 3,5-dinitrobenzoic acid, 2-nitrobenzoic acid, 2,4-dihydroxybenzoic acid, 2,5-dihydroxybenzoic acid, 2,6-dihydroxybenzoic acid, 3,4-dihydroxybenzoic acid, 3,5-dihydroxybenzoic acid, 2-vinyl benzoic acid, 4-vinyl benzoic acid, phthalic acid, terephthalic acid and isophthalic acid.

Among the above-named carboxylic acids of various classes, aromatic carboxylic acids such as salicylic acid and polybasic carboxylic acids such as malonic acid are particularly preferable in respects of their adequate acidity and good solubility in the organic solvent of the photoresist composition consequently giving excellently patterned resist layer.

The amount of the component (E), when added, in the inventive resist composition is from 0.001 to 10 parts by mass or, preferably, from 0.01 to 2.0 parts by mass per 100 parts by mass of the component (A). When the amount thereof is too small, a desirably patterned resist layer can hardly be formed on substrates of certain materials while, when too large, the film thickness reduction in the development treatment of the resist layer cannot be decreased so that the addition of the component loses significance.

It is of course optional according to need that the inventive photoresist composition comprising the above-described essential and optional components is further admixed with various kinds of additives having compatibility including those conventional admixed in chemical-amplification positive-working photoresist compositions such as auxiliary resins to improve the performance of the resist layer, plasticizers, stabilizers, coloring agents, surface active agents and others each in a limited amount.

While the chemical-amplification positive-working photoresist composition is prepared in the form of a uniform solution by dissolving the above-described essential and optional ingredients in an organic solvent, examples of the organic solvents suitable for this purpose include ketones such as acetone, methyl ethyl ketone, cyclohexanone, methyl isoamyl ketone and 2-heptanone, polyhydric alcohols and derivatives thereof such as ethyleneglycol, ethyleneglycol monoacetate, diethyleneglycol, diethyleneglycol monoacetate, propyleneglycol, propyleneglycol monoacetate, dipropyleneglycol, dipropyleneglycol monoacetate as well as monomethyl, monoethyl, monopropyl, monobutyl and monophenyl ethers thereof, cyclic ethers such as dioxane, and esters such as methyl lactate, ethyl lactate, methyl acetate, ethyl acetate, butyl acetate, methyl pyruvate, ethyl pyruvate, methyl methoxypropionate and ethyl ethoxypropionate. These organic solvents can be used either singly or as a mixture of two kinds or more according to need.

The coating solution as the inventive photoresist composition is prepared to have a concentration of nonvolatile ingredients in the range of, usually, 10-80% by mass or, preferably, 10-30% by mass. When the concentration is too low, an unduly long time is taken for drying a wet coating layer to form a dried resist layer while, when too high, difficulties are encountered in handling of the solution due to an unduly high viscosity thereof.

The method for the formation of a patterned resist layer by using the inventive chemical-amplification positive-working photoresist composition can be in accordance with conventional photolithographic resist-patterning methods. For example, a substrate such as a semiconductor silicon wafer, optionally, provided with an antireflection coating film, is coated with the liquid composition on a spinner or an appropriate coating machine followed by drying to form a dried resist layer on the substrate which is pattern-wise exposed to KrF excimer laser beams through a photomask pattern. The thus exposed photoresist layer is, after a post-exposure baking treatment, subjected to a development treatment with a developer solution which is usually a 0.1-10% by mass aqueous solution of tetramethylammonium hydroxide. The radiation source for the patterning exposure is not limited to KrF excimer laser beams but can be electron beams, F₂ laser beams, EUV, X-rays, soft X-rays and others.

In order for the above-described photolithographic patterning procedure to be more successful, the resist layer formed on the substrate surface is subjected to a heat treatment before and after the patterning exposure at 80-150° C. for 30-120 seconds and at 90-150° C. for 30-120 seconds, respectively, on a hot plate.

While the photoresist composition of the present invention is generally applicable to resist patterns of any types including line-and-space patterns, isolated patterns, trench patterns and others, such applicability can be determined roughly by determining the focusing depth latitude and exposure margin. For example, general applicability of the resist composition can be assumed if the resist composition has a focusing depth latitude of at least 1200 nm and an exposure margin of at least 25%. Accordingly., these criteria could be taken as a guide measure for a particular formulation of the composition with the various ingredients.

In the following, the chemical-amplification positive-working photoresist composition is described in more detail by way of examples, which, however, never limit the scope of the present invention in any way. In the following Examples and Comparative Examples, the photoresist compositions prepared there were evaluated by testing of the following properties by the procedures given there.

(1) Sensitivity

A semiconductor silicon wafer provided in advance with a 65 nm thick antireflection coating film by using an organic antireflection coating solution (DUV-44, a product by Brewer Science Co.) was coated on a spinner with the resist composition followed by drying on a hot plate at 100° C. for 90 seconds to form a 0.5 μm thick resist layer, which was exposed on a minifying projection exposure machine (Model FPA-3000EX3, manufactured by Canon Co., NA=0.60) in an exposure dose increased stepwise with an increment of 10 J/m² followed by a post-exposure baking (PEB) treatment at 110° C. for 90 seconds and then subjected to a development treatment with a 2.38% by mass aqueous solution of tetramethylammonium hydroxide at 23° C. for 60 seconds followed by rinse with water for 30 seconds and drying. By conducting the test development treatment in the above-described manner, the sensitivity of the resist composition was taken in the J/m² unit of exposure dose as represented by the minimum dose required to effect complete removal of the resist layer by development.

(2) Cross Sectional Profile of Patterned Resist Layer

A resist layer was patterned in a line-and-space pattern of 200 nm line width in substantially the same manner as in (1) above and the cross section of this patterned resist layer was examined on a scanning electron microscopic (SEM) photograph to evaluate the cross sectional profile to record the results in three ratings of AA for an exactly rectangular cross section, A for a cross section with good orthogonality but having a somewhat rounded top portion and C for an unacceptable cross section with a rounded top portion and trailing skirts.

(3) Critical Pattern Resolution

A resist layer was patterned to form line-and-space patterns of various line widths in substantially the same manner as in (1) above and the smallest line width at which good resolution of the pattern could be obtained was taken as the critical pattern resolution.

(4) Focusing Depth Latitude

A resist layer was patterned to form line-and-space patterns of 200 nm line width with shifts of the focusing point and the maximum range capable of accomplishing a good cross sectional profile of the patterned resist layer was taken as the focusing depth latitude.

(5) Exposure Margin

A resist layer was patterned in line-and-space patterns in substantially the same manner as in (1) above and the exposure margin was given by the latitude of the sensitivity capable of giving a line-and-space pattern of 200 nm line width within a range of ±10% calculated by the equation
Exposure margin, %=(X₂₂₀−X₁₈₀)/X₂₀₀×100,
where X₂₂₀, X₁₈₀ and X₂₀₀ are each the exposure dose capable of giving a line-and-space pattern having a line width of 220 nm, 180 nm and 200 nm, respectively.

### REFERENCE EXAMPLE

Eight polyhydroxystyrene-based substituted copolymeric resins listed in Table 1 below were prepared each from one of the polyhydroxystyrene resins having a different mass-average molecular weight Mw and a different molecular weight dispersion Mw/Mn by substituting a part of the hydroxyl hydrogen atoms with 1-ethoxyethyl groups, tert-butoxycarbonyl groups or tetrahydropyranyl groups as the acid-dissociable solubility-reducing groups in different degrees of substitution in % by moles. Table 1 below summarizes these parameters together with the dissolving rate of each resin which was a value of film thickness decrease in nm/minute when the resin layer formed on a substrate was dipped at 23° C. in a 2.38% by mass aqueous solution of tetramethylammonium hydroxide.

TABLE 1

| | | | | | Dissolv- |
|---|---|---|---|---|---|
| | | | | | ing |
| | | | | % | rate, |
| | Polyhydroxystyrene | | Substituent | substitution, | nm/ |
| Resin | Mw | Mw/Mn | group | by moles | minute |
| a1-1 | 18000 | 1.2 | 1-ethoxy- | 20 | 60 |
| | | | ethyl | | |
| a1-2 | 18000 | 2.4 | 1-ethoxy- | 23 | 80 |
| | | | ethyl | | |
| a2-1 | 10000 | 1.2 | Tert- | 45 | 2 |
| | | | butoxy- | | |
| | | | carbonyl | | |
| a2-2 | 10000 | 2.4 | Tert- | 47 | 2 |
| | | | butoxy- | | |
| | | | carbonyl | | |
| a2-3 | 8000 | 1.2 | tetrahydropyranyl | 43 | 2 |
| a2-4 | 8000 | 3.5 | tetrahydropyranyl | 45 | 2 |
| a1-C1 | 10000 | 1.2 | 1-ethoxy- | 36 | 30 |
| | | | ethyl | | |
| a1-C2 | 8000 | 2.4 | 1-ethoxy- | 38 | 30 |
| | | | ethyl | | |

### Example 1

A mixed resin solution was prepared by dissolving 60 parts by mass of the copolymeric resin a1-1 as the first resinous ingredient a1 and 40 parts by mass of the copolymeric resin a2-1 as the second resinous ingredient a2 each prepared in Reference Example in 500 parts by mass of propyleneglycol monomethyl ether acetate.

The dissolving rate of the a1-a2 resin mixture was determined in the same manner as for a single resin with the resin layer obtained from the above-prepared mixed resin solution of resins a1-1 and a2-1 to give a value of 20 nm/minute.

A chemical-amplification positive-working photoresist composition was prepared by dissolving, in 560 parts by mass of propyleneglycol monomethyl ether acetate, 60 parts by mass of the first copolymeric resin, 40 parts by mass of the second copolymeric resin, 7 parts by mass of bis(cyclohexlsulfonyl) diazomethane and 0.1 part by mass of triethanolamine followed by filtration of the solution through a membrane filter having a pore diameter of 0.2 μm. This photoresist composition was subjected to evaluation of properties for the various testing items (1) to (5) given before to give the results shown in Table 2 below.

### Examples 2 to 9 and Comparative Examples 1 to 4

The experimental procedure in each of these Examples and Comparative Examples was substantially the same as in Example 1 described above excepting replacement of the first and second copolymeric resins with those indicated in Table 2 and, in Example 9, additional admixture of 2 parts by mass of cyclohexanedimethanol divinyl ether. The results of the evaluation tests are summarized in Table 2.

TABLE 2

| | | Resinous ingredient | | | | | | | |
|---|---|---|---|---|---|---|---|---|---|
| | | | | Dissolv- | | | | | |
| | | | | ing | | | | | |
| | | | | rate, | Testing item | | | | |
| | | | | nm/ | (1) | | (3) | (4) | |
| | | a1 | a2 | minute | J/m² | (2) | nm | nm | (5) % |
| Exam- | 1 | a1-1 | a2-1 | 20 | 500 | AA | 160 | 1400 | 32 |
| ple | 2 | a1-2 | a2-2 | 25 | 540 | A | 170 | 1200 | 29 |
| | 3 | a1-1 | a2-2 | 30 | 510 | A | 160 | 1200 | 29 |
| | 4 | a1-2 | a2-1 | 25 | 530 | A | 170 | 1200 | 30 |
| | 5 | a1-1 | a2-3 | 20 | 470 | AA | 160 | 1400 | 33 |
| | 6 | a1-2 | a2-4 | 30 | 490 | A | 170 | 1200 | 30 |
| | 7 | a1-1 | a2-4 | 25 | 470 | A | 170 | 1200 | 29 |
| | 8 | a1-2 | a2-3 | 25 | 480 | A | 170 | 1200 | 28 |
| | 9 | a1-1 | a2-1 | 20 | 560 | A | 150 | 1600 | 25 |
| Com- | 1 | a1-c1 | a2-1 | — | 480 | AA | 160 | 1000 | 25 |
| para- | 2 | a1-c2 | a2-2 | — | 500 | A | 170 | 800 | 22 |
| tive | 3 | a1-c1 | a2-3 | — | 480 | AA | 160 | 1000 | 27 |
| Exam- | 4 | a1-c2 | a2-4 | — | 510 | A | 170 | 800 | 23 |
| ple | | | | | | | | | |

1. A chemical-amplification positive-working photoresist composition comprising (A) a resinous ingredient capable of being imparted with increased solubility in alkali by interacting with an acid as comprising unsubstituted hydroxystyrene units and hydroxystyrene units substituted for the hydroxyl hydrogen atoms by acid-dissociable solubility-reducing groups and (B) a compound capable of generating an acid by irradiation with a radiation, wherein the component (A) is a combination of (a1) a first copolymeric resin having a mass-average molecular weight of 15000 to 30000 with a molecular weight dispersion Mw/Mn of 1 to 4 and containing 25% by moles or less of hydroxystyrene units substituted by acid-dissociable solubility-reducing groups and (a2) a second copolymeric resin having a mass-average molecular weight of 3000 to 10000 with a molecular weight dispersion Mw/Mn of 1 to 4 and containing at least 35% by moles of hydroxystyrene units substituted by acid-dissociable solubility-reducing groups, the acid-dissociability of the acid-dissociable solubility-reducing groups in the first copolymeric resin (a1) being higher than the acid-dissociability of the acid-dissociable solubility-reducing groups in the second copolymeric resin (a2).

2. The chemical-amplification positive-working photoresist composition according to claim 1 wherein the acid-dissociable solubility-reducing groups in the first copolymeric resin (a1) is an alkoxyalkyl group or the acid-dissociable solubility-reducing group in the second copolymeric resin (a2) is selected from the group consisting of tertiary-alkyloxycarbonyl groups, tertiary-alkyl groups, tertiary-alkoxycarbonylalkyl groups and cyclic ether groups.

3. The chemical-amplification positive-working photoresist composition according to claim 2 wherein the alkoxyalkyl group in the first copolymeric resin (a1) is an 1-ethoxyethyl group or 1-isopropoxyethyl group and the tertiary-alkyloxycarbonyl group, tertiary-alkyl group, tertiary-alkoxycarbonylalkyl group and cyclic ether group in the second copolymeric resin (a2) are tert-butyloxycarbonyl group, tert-butyl group, tert-butyloxycarbonylmethyl group and tetrahydropyranyl group, respectively.

4. The chemical-amplification positive-working photoresist composition according to claim 1 wherein the molecular weight dispersions Mw/Mn are each from 1.0 to 1.5.

5. The chemical-amplification positive-working photoresist composition according to claim 1 wherein the first copolymeric resin (a1) is a polyhydroxystyrene resin containing from 5 to 25% by moles of hydroxystyrene units substituted for the hydroxyl hydrogen atoms by chain alkoxyalkyl groups and the second copolymeric resin (a2) is a polyhydroxystyrene resin containing from 35 to 60% by moles of hydroxystyrene units substituted for the hydroxyl hydrogen atoms by acid-dissociable solubility-reducing groups selected from the group consisting of tertiary-alkyloxycarbonyl groups, tertiary-alkyl groups, tertiary-alkoxycarbonylalkyl groups and cyclic ether groups.

6. The chemical-amplification positive-working photoresist composition according to claim 1 wherein the component (A) is a combination of the first and second copolymeric resins (a1) and (a2) in a mass proportion in the range from 1:9 to 9:1.

7. The chemical-amplification positive-working photoresist composition according to claim 1 which further comprises (C) a polyvinyl ether compound capable of being crosslinked by heating.

8. The chemical-amplification positive-working photoresist composition according to claim 7 wherein the component (C) is a compound represented by the general formula
A[O—(RO)ₘ—CH═CH₂]ₙ
in which A is a divalent to pentavalent residue of an organic compound, R is an alkylene group having 1 to 4 carbon atoms, the subscript m is 0 or an integer of 1 to 5 and the subscript n is an integer of 2 to 5.

9. The chemical-amplification positive-working photoresist composition according to claim 1 which further comprises (D) an amine compound.

10. The chemical-amplification positive-working photoresist composition according to claim 1 which further comprises (E) a carboxylic acid.
